(19) United States
(12) Patent Application Publication
(10) Pub. No.: US 2026/0298278 A1
(43) Pub. Date: Oct. 1, 2026

(54) PYRO SEPARATION APPARATUS AND SEPARATION METHOD HAVING DUAL SEPARATION FUNCTION AND COMPATIBILITY WITH VARIOUS FASTENERS

(71) Applicant: AGENCY FOR DEFENSE DEVELOPMENT, Daejeon (KR)

(72) Inventors: KIUN KIM, Daejeon (KR); HONGIL KIM, Daejeon (KR); SOOHONG AHN, Daejeon (KR); HANBI BYUN, Daejeon (KR)

(21) Appl. No.: 19/576,785

(22) Filed: Mar. 24, 2026

(30) Foreign Application Priority Data
Mar. 27, 2025 (KR) 10-2025-0039295
Mar. 27, 2025 (KR) 10-2025-0039298

(51) Int. Cl. F16B 31/00

(52) U.S. Cl. CPC F16B 31/005

(57) ABSTRACT

The present disclosure provides a pyro separation apparatus and a separation method having a dual separation function and compatibility with various fasteners.

The apparatus includes an explosive bolt configured such that a cutting portion is separated by explosion of an internal explosive, a bolt head-type nut into which one side of the explosive bolt is inserted, and a pyro bolt including a second igniter, a cylinder having one side opened, a piston inserted into the cylinder, a split wedge restraining the bolt head-type nut, and a case surrounding the split wedge and the cylinder.

When power is applied to the second igniter, the split wedge expands radially to release restraint of the bolt head-type nut, thereby separating a structure, and separation is performed by operation of at least one of the explosive bolt and the pyro bolt.

### CROSS-REFERENCE TO RELATED APPLICATIONS

This application claims priority to Korean Patent Application No. 10-2025-0039295 filed on Mar. 27, 2025, and Korean Patent Application No. 10-2025-0039298 filed on Mar. 27, 2025, pursuant to 35 U.S.C. § 119, the entire disclosures of which are incorporated herein by reference.

### BACKGROUND OF THE DISCLOSURE

### 1. Field of the Disclosure

The present disclosure relates to a field of pyro-based separation technology for rapidly and reliably releasing and separating a fastening state of a structure, device, apparatus, module, payload, or the like when necessary. More particularly, the present disclosure relates to a pyro separation apparatus and a separation method having a dual separation function and compatibility with various fasteners, in which a separation mechanism operated by an explosive charge, an igniter, or a pressure generating means is employed, and a first separation means and a second separation means are provided together within a single system so that separation can be performed by the other separation means even when a malfunction occurs in one of the separation means.

In addition, by employing a bolt head-type nut as an intermediate component, the present disclosure provides a universal fastening compatibility structure configured to selectively receive and separate fasteners of various shapes and specifications, including an explosive bolt, a general bolt, a bidirectional threaded fastener, a large-diameter fastener, a small-diameter fastener, a countersunk-head fastener, and a round-head fastener.

Accordingly, the present disclosure relates to a pyro separation apparatus and a separation method having a dual separation function and compatibility with various fasteners, which can be applied to fields where separation reliability, structural stability, application flexibility, and emergency response capability are critically required, such as aerospace, space systems, defense systems, launch vehicles, satellites, aircraft, guided weapons, separable structures, emergency deployment devices, and high-reliability fastening release systems.

### 2. Description of the Related Art

In general, separation devices are essential technologies in the aerospace industry, the defense industry, and similar technical fields.

For example, the separation process of a launch vehicle (such as a rocket, satellite, or spacecraft) is essential for performing step-by-step missions after launch.

In such a case, if the separation of the launch vehicle fails, the entire mission may fail. Accordingly, high reliability and operational stability are required.

Such separation devices may be used in various applications, including rocket stage separation of launch vehicles, satellite separation, and fairing separation.

Hereinafter, FIGS. 1 and 2 are diagrams for explaining the configuration and operating principle of related art technologies, and the reference numerals shown therein are distinguished from those used in the present disclosure.

FIG. 1 is a diagram illustrating components and an operating principle of an explosive bolt.

Generally, explosive bolts are used in the aerospace industry, the defense industry, and other high-reliability separation systems.

An explosive bolt is used when it is necessary to rapidly and accurately separate a structural coupling portion, and cuts a structure by detonating an internal explosive charge in response to an electrical signal.

Such explosive bolts are essential components used in satellite separation, rocket stage separation, and spacecraft fairing separation.

Referring to the left diagram of FIG. 1, an igniter (10) is connected to an explosive bolt (11) having a structural member (12).

The igniter (10) is a device for igniting a charge inside the explosive bolt (11), and ignites the explosive when an electrical signal is applied.

The explosive bolt (11) is formed in the shape of a bolt for firmly fixing the structural member (12), and includes a cutting portion (13) where controlled cutting occurs during an explosion.

By the predesigned cutting portion (13), separation occurs precisely at the cutting portion (13) when the explosive charge is detonated.

The igniter (10) and the explosive bolt (11) are firmly coupled in a threaded manner so as to maintain a stable fastening state before separation.

Referring to the right side of FIG. 1, when electrical power is supplied to the igniter (10), an ignition signal is generated.

High-temperature and high-pressure gases generated by the explosion separate the cutting portion (13) of the explosive bolt (11).

As the cutting portion (13) of the explosive bolt (11) is separated, the structural member (12) coupled thereto is immediately released.

This separation process is completed within several milliseconds, allowing precise timing control.

Accordingly, the structural member (12) can be separated safely and rapidly, and reliable cutting of the explosive bolt (11) enables the mission to proceed to a subsequent stage without interruption.

However, such explosive bolts (11) may fail to detonate due to internal explosive charge defects or igniter (10) malfunctions.

In such cases, separation failure may occur, which may critically affect the entire mission.

FIG. 2 illustrates components and an operating principle of a pyro bolt.

A pyro bolt (20) is used in aerospace systems, defense systems, and satellite launch vehicles in order to safely and rapidly separate structural members (24, 25).

The pyro bolt (20) employs pyro technology and uses a mechanical separation mechanism rather than a direct explosive cutting mechanism.

Accordingly, the pyro bolt (20) can minimize shock, thereby reducing potential damage to sensitive equipment.

Referring to the left side of FIG. 2, the pyro bolt (20) includes a bolt (21), a wedge (22), an igniter (23), and structural members (24, 25).

The bolt (21) is a component configured to firmly fasten the structural members, and a head portion of the bolt (21) is positioned inside the pyro bolt (20).

The wedge (22) is configured to prevent separation of the bolt head by firmly fixing the bolt head so that the fastening state of the structural members (24, 25) is maintained.

The igniter (23) receives an electrical signal and activates the pyro device, thereby serving as a core ignition mechanism.

Structural members (24, 25) are coupled by the pyro bolt (20), and are fastened through the bolt (21) and the wedge (22) so as to be stably fixed until separation occurs.

Referring to the right side of FIG. 2, when power is supplied to the igniter (23), the pyro bolt (20) is actuated so that the wedge (22) expands in a radial direction.

Due to the expansion of the wedge (22), constraint of the bolt head is released, and the bolt (21) is ejected outward by an internally provided force, thereby releasing the fastening state of the structural members (24, 25).

Accordingly, the structural members (24, 25) can be safely and rapidly separated, and are minimized during the separation process are minimized so that damage to surrounding devices can be prevented.

However, when such a pyro bolt (20) is used, separation failure may occur due to internal defects, for example malfunction of the wedge (22), and such separation failure may lead to mission failure.

In addition, based on the operating principles of the explosive bolt (11) and the pyro bolt (20), the two bolts cannot be directly connected to operate as a single separation device.

That is, in the case of the explosive bolt, an igniter must be mounted to a head portion of the bolt in order to actuate an internal explosive charge. However, if the bolt head portion is positioned inside the pyro bolt (20), the igniter cannot be properly installed or operated.

Furthermore, in order to prevent separation using the wedge (22), the head portion of the explosive bolt (11) must also be configured so that separation can be restrained by the wedge (22). This requires redesign of the explosive bolt (11), and therefore an already developed explosive bolt (11) cannot be directly used.

Meanwhile, in the aerospace and defense industries, high reliability and safety are required in fastening and separation processes of various flight systems such as launch vehicles, satellites, and missiles.

A pyro-separation device used in such fields is designed to rapidly and safely release a connection state between two structures through operation of pyro technology triggered by an electrical signal.

Such pyro-separation devices exhibit characteristics such as low shock, rapid separation speed, and high reliability, and therefore are essential components in precision systems such as space launch vehicles.

In particular, pyro bolts and pyro nuts are core components of such pyro-separation devices.

A pyro bolt minimizes shock generated during separation and prevents damage to a payload, while a pyro nut supports rapid and reliable separation of fastened components during the separation process.

Such devices are developed in a customized manner according to specific fastening conditions and separation requirements, and perform key functions in the separation procedure.

However, conventional pyro-separation devices generally require a specialized bolt and a specialized nut and are designed in a customized manner according to requirements of a particular application.

Although such specialized components play an important role in ensuring performance and reliability of the separation device, several drawbacks exist.

For example, since conventional pyro-separation devices are manufactured to be optimized for specific fastening conditions, the devices cannot be used when fastening parameters such as diameter, length, or thread specification are changed, and separate customized devices must be newly manufactured to meet new fastening conditions. Accordingly, compatibility with various application environments is limited.

In addition, due to the customized manufacturing approach, manufacturing costs increase and production time becomes longer. Particularly in the case of small production volumes, economic efficiency decreases and significant time and cost are required during development and application.

Furthermore, since conventional pyro bolts and pyro nuts are suitable only for specific design structures, structural redesign is required when design changes are needed. As a result, rapid application becomes difficult when launch vehicle designs are modified, thereby reducing operational flexibility.

Moreover, when fastening components are damaged or changed during development of a launch vehicle, immediate procurement of replacement parts becomes difficult, making it difficult to respond quickly to emergency situations and resulting in problems such as operational interruption and delays in development schedules.

### RELATED PATENT DOCUMENTS

Korean Registered Patent Publication No. 10-2619334
Korean Registered Patent Publication No. 10-2738793

### SUMMARY OF THE DISCLOSURE

A first object of the present disclosure is to provide a pyro separation apparatus and a separation method having a dual separation function and compatibility with various fasteners, in which separation reliability is improved by combining a pyro bolt and an explosive bolt into a dual separation device so that separation can be performed even when only one of the two operates.

A second object of the present disclosure is to provide a pyro separation apparatus and a separation method having a dual separation function and compatibility with various fasteners, in which a bolt-head type nut is introduced so that an already developed explosive bolt can be directly used without redesign, thereby reducing design and development costs, shortening development time, and improving design flexibility.

A third object of the present disclosure is to provide a pyro separation apparatus and a separation method having a dual separation function and compatibility with various fasteners, in which a low-shock operating mechanism of a pyro bolt and a rapid actuation characteristic of an explosive bolt are combined so that are minimized during a separation process are minimized, thereby preventing damage to precision equipment, maintaining stability of a launch vehicle, and improving mission success rate.

A fourth object of the present disclosure is to provide a pyro separation apparatus and a separation method having a dual separation function and compatibility with various fasteners, which are designed so that the apparatus can be combined with explosive bolts of various sizes and shapes simply by changing a size of the bolt-head type nut, thereby increasing design flexibility, expanding an application range, and providing adaptability to various missions.

A fifth object of the present disclosure is to provide a pyro separation apparatus and a separation method having a dual separation function and compatibility with various fasteners, in which a pyro bolt and an explosive bolt are combined into a single system while realizing a design suitable for mass production through structural simplification and reduced manufacturing costs.

A sixth object of the present disclosure is to provide a pyro separation apparatus and a separation method having a dual separation function and compatibility with various fasteners, in which independent operating mechanisms of the pyro bolt and the explosive bolt are provided through a dual separation system so that it is possible to quickly diagnose which system has encountered a problem, thereby enabling rapid maintenance and ensuring mission continuity.

A seventh object of the present disclosure is to provide a pyro separation apparatus and a separation method capable of using various fasteners, in which a bolt-head type nut is introduced so that various fasteners, including a general bolt, a large-diameter fastener, a small-diameter fastener, and a bidirectional threaded fastener, can be accommodated by a single device, thereby reducing time and cost required for development of a new device.

An eighth object of the present disclosure is to provide a pyro separation apparatus and a separation method capable of using various fasteners, in which an internal threaded portion of the bolt-head type nut can be post-machined according to specifications of various fasteners so that a basic structure is maintained while only a thread specification is post-machined as necessary, thereby reducing manufacturing costs and simplifying manufacturing processes.

A ninth object of the present disclosure is to provide a pyro separation apparatus and a separation method capable of using various fasteners, in which standardized bolt-head type nuts and various commercial fasteners are used so that even when a fastener is damaged, immediate replacement and rapid response are possible, thereby enabling flexible and effective response to urgent demands.

A tenth object of the present disclosure is to provide a pyro separation apparatus and a separation method capable of using various fasteners, in which a modular design is adopted so that only the bolt-head type nut is changed according to a fastener specification while the remaining parts of an existing system are maintained unchanged, thereby eliminating a need for repeated performance verification tests, facilitating reliability assurance, and providing stable performance in various environments.

In order to achieve those objects, an aspect of the present disclosure provides a pyro separation apparatus having a dual separation function and compatibility with various fasteners for separating a fastening state of a structural member, the pyro separation apparatus comprising:
an explosive bolt configured such that a cutting portion is separated by explosion of an internal explosive;
a bolt head-type nut configured such that one side of the explosive bolt is inserted therein; and
a pyro bolt including a second igniter, a cylinder having one side open, a piston inserted into the cylinder, a split wedge configured to restrain the bolt head-type nut, and a case surrounding the split wedge and an outer side of the cylinder, when electrical power is applied to the second igniter, high pressure builds up in the space between a cylinder and a piston.

This pressure pushes the cylinder and the piston, separately.

After that, the split wedge expands in a radial direction to release restraint of the bolt head-type nut,
wherein the explosive bolt performs separation of the structural member by separation of the cutting portion when power is applied to a first igniter,
wherein the pyro bolt performs separation of the structural member by releasing restraint of the bolt head-type nut by expansion of the split wedge, and
wherein separation of the structural member is performed by operation of the explosive bolt, the pyro bolt, or both.

In some exemplary embodiment, the explosive bolt may include the first igniter and the cutting portion having one side connected to the first igniter,
the cutting portion may be positioned between one side and the other side of the explosive bolt, and
the cutting portion may be separated when power is applied to the first igniter.

In some exemplary embodiment, the bolt head-type nut may be formed in a shape having one side open, and
a space may be formed in the bolt head-type nut for accommodating a threaded part of the explosive bolt or one side of a fastener.

In some exemplary embodiment, the split wedge may restrain a vicinity of an outer surface of the bolt head-type nut, and may be restrained by an inner surface of one side of the cylinder and by one end of the piston.

In some exemplary embodiment, the case may be formed to accommodate and protect the split wedge and the cylinder, and
an initial fixing member may be disposed outside the case to fix the case.

In some exemplary embodiment, the explosive bolt and the pyro bolt may be arranged and configured to perform a normal separation function even when the explosive bolt and the pyro bolt operate simultaneously.

In some exemplary embodiment, the bolt head-type nut may be formed such that a diameter, a length, or both are changeable so as to be fastened with explosive bolts of a plurality of sizes.

In some exemplary embodiment, the pyro separation apparatus may further comprise:
a sensor unit configured to detect an operating state of the explosive bolt and the pyro bolt; and
a control unit configured to control an operation sequence of the first igniter and the second igniter.

In addition, in order to achieve the aforementioned objects, another aspect of the present disclosure provides a pyro separation apparatus capable of using various fasteners for separating a fastening state of a structural member, the pyro separation apparatus comprising:
a second igniter;
a cylinder having one side open;
a piston inserted into the open one side of the cylinder;
a bolt head-type nut installed in series with the piston and formed such that a fastener is inserted or coupled thereto;
a split wedge configured to restrain a vicinity of an outer surface of the bolt head-type nut; and
a case surrounding the split wedge and an outer side surface of the cylinder;
wherein, when power is applied to the second igniter, pressure is generated,
wherein the cylinder moves by the pressure,
wherein, according to movement of the cylinder, the split wedge expands in a radial direction to release restraint of the bolt head-type nut,
wherein the bolt head-type nut is configured to be separated by a pushing force of the piston caused by the pressure, and
wherein the bolt head-type nut is formed to be selectively coupled with a fastener selected from the group consisting of a general bolt, a large-diameter or small-diameter fastener, a bidirectional threaded fastener, a countersunk-head fastener, and a round-head fastener.

In some exemplary embodiment, the bolt head-type nut may be formed in a cylindrical structure having one side open, and a space may be provided in the bolt head-type nut for accommodating one side of the fastener.

In some exemplary embodiment, the bolt head-type nut may be formed such that a diameter, a length, or both are changeable so as to be compatible with fasteners of various sizes.

In some exemplary embodiment, an internal threaded portion of the bolt head-type nut may be formed to be post-processable according to a specification of an applicable fastener.

In some exemplary embodiment, the split wedge may have a radially divisible structure, and
when the cylinder moves, a fixing force may be released so that the split wedge expands in a radial direction.

In some exemplary embodiment, the case may surround the cylinder and the split wedge from the outside, and
the case may maintain structural integrity of internal elements of the apparatus and may protect the internal elements from external impact.

In some exemplary embodiment, the pyro separation apparatus may further comprise:
a sensor unit configured to detect an operating state of the pyro separation apparatus; and
a control unit configured to control an operation of the second igniter.

Meanwhile, in order to achieve the aforementioned objects, still another aspect of the present disclosure provides a pyro separation method having a dual separation function and compatibility with various fasteners for separating a fastening state of a structural member, the method comprising:
inserting one side of an explosive bolt or a fastener into a bolt head-type nut having one side open;
inserting the other side of the bolt head-type nut into a piston of a pyro bolt having one side open;
restraining the bolt head-type nut by a split wedge;
applying power to a first igniter to separate a cutting portion of the explosive bolt; and
applying power to a second igniter to generate pressure, moving a cylinder by the pressure, expanding the split wedge in a radial direction according to movement of the cylinder to release restraint of the bolt head-type nut, and separating the bolt head-type nut by a pushing force of the piston caused by the pressure;
wherein separation of the structural member is performed by operation of the explosive bolt, the pyro bolt, or both.

In some exemplary embodiments, a step of separating the cutting portion of the explosive bolt by the first igniter and a step of releasing the restraint of the bolt head-type nut by the second igniter may be selectively performed or simultaneously performed.

In some exemplary embodiments, the fastener may be selected from the group consisting of a general bolt, a large-diameter or small-diameter fastener, a bidirectional threaded fastener, a countersunk-head fastener, and a round-head fastener.

In some exemplary embodiments, at least one of a diameter, a length, or an internal thread specification of the bolt head-type nut may be adjusted according to a specification of an applicable fastener or explosive bolt.

In some exemplary embodiments, the pyro separation method may further comprise:
detecting an operating state of the explosive bolt and the pyro bolt by a sensor unit; and
controlling an operation sequence of the first igniter and the second igniter by a control unit.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, by applying a dual separation mechanism so that the separation function can be performed even when only one of a pyro bolt and an explosive bolt operates, even if the reliability of each bolt is somewhat low, the dualized design maximizes the separation reliability of the entire system and minimizes the possibility of separation failure, thereby improving stability and safety of a flight vehicle and other important systems.

In addition, according to the present disclosure, by introducing a bolt-head type nut, an already developed explosive bolt can be used as it is, and the explosive bolt can be combined with the pyro bolt without separate redesign, thereby reducing design complexity and development cost, which leads to saving of time and resources and shortening of a development period of a project.

In addition, according to the present disclosure, by adjusting a size of the bolt-head type nut, the apparatus can be used in combination with explosive bolts of various sizes and types, and even when general fasteners are used instead of explosive bolts, the separation function of the pyro bolt can be maintained, thereby providing wide applicability and facilitating customized design according to requirements of various launch vehicles and structures.

In addition, according to the present disclosure, whereas it was difficult to identify a cause of malfunction when separation failure occurred in the related art, the dual separation device of the present disclosure can distinguish and confirm an operating state based on whether one of the bolts operates, thereby reducing time and cost required for maintenance and troubleshooting through effective cause analysis.

In addition, according to the present disclosure, a safe and highly reliable separation system can be provided in fields requiring high reliability, such as launch vehicle separation, satellite separation, and ballistic systems, and by preventing critical separation failure, the present disclosure can contribute to improvement of a mission success rate.

In addition, according to the present disclosure, fasteners of various sizes and shapes can be applied to a single separation device, so that even when fastening conditions are changed there is no need to develop a new separation device, and fasteners having different diameters or special thread structures can also be made compatible through simple post-machining, thereby securing versatility applicable to various launch vehicles and structures through a standardized design.

In addition, according to the present disclosure, since the same separation mechanism is maintained through a modular design, a verification burden can be reduced, and a radial expansion split wedge structure of the pyro bolt provides a highly reliable separation operation, maintains stability of a structure, and provides stable and reliable separation performance even in various environments such as vibration and temperature changes.

In addition, according to the present disclosure, when an existing pyro bolt is damaged or separation failure occurs, commercial fasteners can be utilized and flexible response is possible even in emergency situations, thereby enabling rapid maintenance and reuse without delay of a launch vehicle, shortening a launch preparation period, and reducing operational costs.

In addition, according to the present disclosure, a size and structure of the bolt-head type nut can be adjusted according to fasteners of various sizes and structures, thereby enabling customized application according to fastening conditions required in various industries such as satellites, launch vehicles, and military supplies, and due to the modular design, a single design can be applied to various application products, thereby providing excellent expandability.

In addition, according to the present disclosure, when the pyro bolt operates, a second igniter and a piston structure provide pressure required for a separation operation so that a safe separation process can be provided and risk of excessive damage can be reduced, thereby improving safety of the separation operation and providing a reliable separation function even in fields requiring high safety and precision such as aerospace and defense industries.

### BRIEF DESCRIPTION OF THE DRAWINGS

FIG. 1 is a view illustrating components and an operating principle of an explosive bolt.

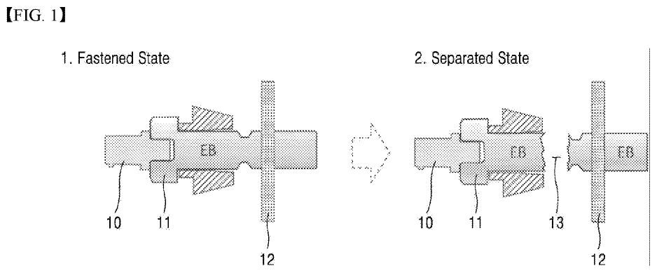

FIG. 2 is a view illustrating components and an operating principle of a pyro bolt.

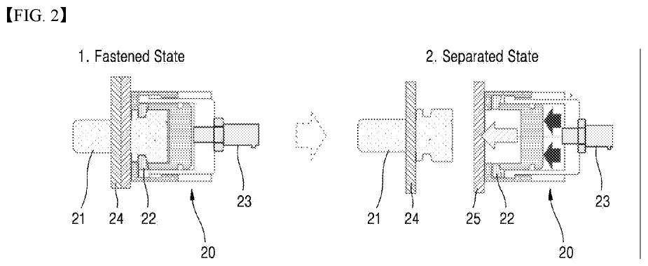

FIG. 3 is a view illustrating components and an operating principle of a dual separation apparatus using a pyro explosive bolt according to an exemplary embodiment of the present disclosure.

FIG. 4 is a view illustrating examples of application of various sizes of the pyro explosive bolt and fasteners in the dual separation apparatus using the pyro explosive bolt according to another exemplary embodiment of the present disclosure.

FIG. 5 is a view illustrating a configuration of a pyro separation apparatus capable of using various fasteners according to another exemplary embodiment of the present disclosure.

FIG. 6 is a flowchart illustrating an overall flow of a configuration or preparation stage of the dual separation apparatus in a dual separation method using the pyro explosive bolt according to an exemplary embodiment of the present disclosure.

FIG. 7 is a flowchart illustrating an overall flow of an actual operation stage in a pyro separation method capable of using various fasteners according to another exemplary embodiment of the present disclosure.

FIG. 8 is a view illustrating a first step of the pyro separation method capable of using various fasteners according to another exemplary embodiment of the present disclosure.

FIG. 9 is a view illustrating a second step of the pyro separation method capable of using various fasteners according to another exemplary embodiment of the present disclosure.

FIG. 10 is a view illustrating a third step of the pyro separation method capable of using various fasteners according to another exemplary embodiment of the present disclosure.

FIG. 11 is a view illustrating a fourth step of the pyro separation method capable of using various fasteners according to another exemplary embodiment of the present disclosure.

FIG. 12 is a view illustrating a configuration of a pyro separation apparatus capable of using various fasteners according to still another exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

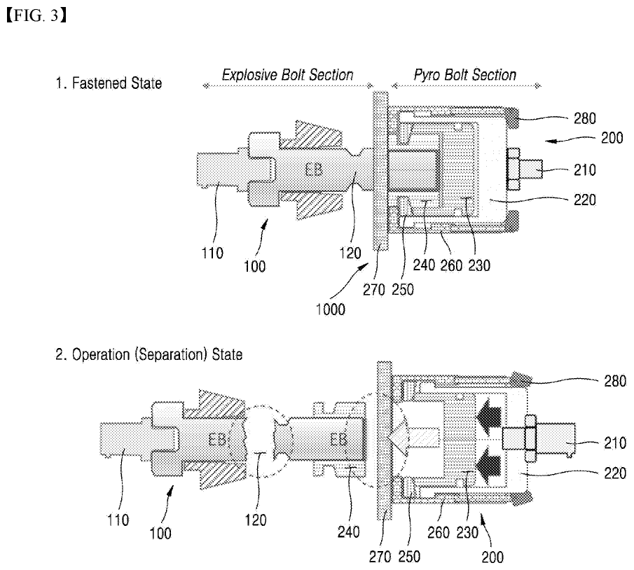

FIG. 3 is a view illustrating components and an operating principle of a dual separation apparatus using a pyro explosive bolt according to an exemplary embodiment of the present disclosure.

Referring to FIG. 3, a pyro separation apparatus (1000) having a dual separation function and compatibility with various fasteners is a dual separation apparatus in which an explosive bolt (100) and a pyro bolt (200) are combined.

That is, the pyro separation apparatus (1000) having the dual separation function and compatibility with various fasteners according to the present embodiment is a dual separation apparatus that improves reliability by providing a dual separation mechanism by combining the explosive bolt (100) and the pyro bolt (200).

In addition, the pyro separation apparatus (1000) having the dual separation function and compatibility with various fasteners according to the present disclosure may include the explosive bolt (100), a bolt head-type nut (240), and the pyro bolt (200).

The explosive bolt (100) separates a cutting portion by explosion of an internal explosive when power is applied to a first igniter (110).

In addition, one side of the explosive bolt (100) is inserted into the bolt head-type nut (240).

Meanwhile, when power is applied to a second igniter (210), the pyro bolt (200) causes a split wedge (250), which restrains the bolt head-type nut (240), to expand in a radial direction to release restraint of the bolt head-type nut (240) being restrained.

The explosive bolt (100) includes the first igniter (110) and the cutting portion (120).

One side of the cutting portion (120) is connected to the first igniter (110), the cutting portion (120) is positioned between one side and the other side of the explosive bolt (100), and the cutting portion (120) is separated by explosion of the internal explosive when power is applied to the first igniter (110).

In addition, one side of the explosive bolt (100) is inserted into the bolt head-type nut (240).

Meanwhile, when power is applied to the second igniter (210), the pyro bolt (200) causes the split wedge (250), which restrains the bolt head-type nut (240), to expand in a radial direction to release restraint of the bolt head-type nut (240) being restrained.

The explosive bolt (100) separates the cutting portion (120) by explosion of the internal explosive when power is applied to the first igniter (110).

The pyro bolt (200) includes the second igniter (210), a cylinder (220), a piston (230), the bolt head-type nut (240), the split wedge (250), a case (260), a structural member (270), and an initial fixing member (280).

The cylinder (220) has a shape in which one side is open.

The piston (230) is inserted into the cylinder (220) and has a shape in which one side is open.

The bolt head-type nut (240) is inserted into the piston (230) and has a shape in which one side is open.

The split wedge (250) restrains the bolt head-type nut (240).

More specifically, the split wedge (250) restrains a vicinity of an outer surface of one side of the bolt head-type nut (240), and is restrained by an inner surface of one side of the cylinder (220) and one end of the piston (230).

The case (260) is formed to surround outer surfaces of the split wedge (250) and the cylinder (220).

More specifically, the case (260) surrounds the outer surfaces of the split wedge (250) and the cylinder (220).

The initial fixing member (280) is disposed outside the case (260) in a circumferential shape to fix the case (260).

When power is applied to the second igniter (210), the pyro bolt (200) causes the split wedge (250), which restrains the bolt head-type nut (240), to expand in a radial direction to release restraint of the bolt head-type nut (240) being restrained.

The explosive bolt (100) includes the first igniter (110) and the cutting portion (120).

One side of the cutting portion (120) is connected to the first igniter (110), the cutting portion (120) is positioned between one side and the other side of the explosive bolt (100), and the cutting portion (120) is separated by explosion of the internal explosive when power is applied to the first igniter (110).

The pyro bolt (200) includes the second igniter (210), the cylinder (220), the piston (230), the bolt head-type nut (240), the split wedge (250), the case (260), the structural member (270), and the initial fixing member (280).

The cylinder (220) has a shape in which one side is open.

The second igniter (210) is connected to the other side of the cylinder (220) having one side open.

The piston (230) is inserted into the cylinder (220) and has a shape in which one side is open.

The bolt head-type nut (240) is inserted into the piston (230) and has a shape in which one side is open.

The split wedge (250) restrains the bolt head-type nut (240).

More specifically, the split wedge (250) restrains a vicinity of an outer surface of one side of the bolt head-type nut (240), and is restrained by an inner surface of one side of the cylinder (220) and one end of the piston (230).

The case (260) accommodates and protects the split wedge (250) and the cylinder (220).

More specifically, the case (260) surrounds the outer surfaces of the split wedge (250) and the cylinder (220).

The initial fixing member (280) is disposed outside the case (260) in a circumferential shape to fix the case (260).

When power is applied to the second igniter (210), the pyro bolt (200) causes the split wedge (250), which restrains the bolt head-type nut (240), to expand in a radial direction to release restraint of the bolt head-type nut (240) being restrained.

Here, the explosive bolt (100) and the pyro bolt (200) may be arranged and configured to perform a normal separation function even when the explosive bolt (100) and the pyro bolt (200) operate simultaneously.

In addition, separation may be performed when at least one of the explosive bolt (100) or the pyro bolt (200) operates.

In addition, the bolt head-type nut (240) may be changeable in size so as to be fastened with explosive bolts (100) of a plurality of sizes.

Meanwhile, the pyro separation apparatus (1000) having the dual separation function and compatibility with various fasteners according to the present disclosure may further include a sensor unit and a control unit.

The sensor unit may detect an operating state of the explosive bolt (100) and the pyro bolt (200).

In addition, the control unit may control an operation sequence of the first igniter (110) and the second igniter (210).

That is, the control unit may cause only the explosive bolt (100) to operate or may cause only the pyro bolt (200) to operate.

In addition, the control unit may cause the explosive bolt (100) and the pyro bolt (200) to operate simultaneously.

In other words, the apparatus according to the present embodiment relates to the pyro separation apparatus (1000) having the dual separation function and compatibility with various fasteners used in aerospace and defense industries.

The present embodiment combines operating concepts of the explosive bolt (100) and the pyro bolt (200) so that separation is performed even when only one of the two bolts operates.

Through this configuration, reliability problems of a single separation device can be solved and stability and reliability of the separation apparatus can be improved.

The explosive bolt (100) includes the first igniter (110) and has the cutting portion (120) including an internal explosive.

The explosive bolt (100) has a generally cylindrical structure, and has a head portion connected to the first igniter (110) at one side and threads formed at the other side.

When power is applied to the first igniter (110), the internal explosive explodes and the cutting portion (120) is separated.

The other side of the explosive bolt (100) is inserted into the bolt head-type nut (240) and operates in conjunction with the pyro bolt (200).

The bolt head-type nut (240) has a cylindrical structure with one side open, and a space for accommodating the head portion of the explosive bolt (100) is provided therein.

The bolt head-type nut (240) may be adjusted to various diameters and lengths and may be coupled with explosive bolts (100) of a plurality of sizes.

When the explosive bolt (100) operates, it is separated together with the explosive bolt (100).

In addition, when the pyro bolt (200) operates, restraint of the bolt head-type nut (240) is released by expansion of the split wedge (250) and separation is performed.

The bolt head-type nut (240) is restrained by the other side of the explosive bolt (100) and the split wedge (250) of the pyro bolt (200), and during separation the two devices operate simultaneously or independently.

The second igniter (210) of the pyro bolt (200) is a power supply device for operating the pyro bolt (200).

The split wedge (250) is an element that restrains the bolt head-type nut (240), and expands in a radial direction when power is applied to release the restraint.

The cylinder (220) and the piston (230) are mechanical components inside the pyro bolt (200) and support expansion of the split wedge (250).

The cylinder (220) has a cylindrical shape with one side open, and the piston (230) is inserted into the cylinder (220).

The split wedge (250) is inserted into the piston (230) and is formed to expand in a radial direction.

When power is applied to the second igniter (210), the split wedge (250) expands to release restraint of the bolt head-type nut (240) and perform the separation function.

The pyro bolt (200) is a core device that restrains the bolt head-type nut (240) and may operate together with the explosive bolt (100) or independently.

Meanwhile, the control unit controls an operation sequence of the explosive bolt (100) and the pyro bolt (200) so that normal separation is performed without mutual interference.

The sensor unit monitors operating states of the explosive bolt (100) and the pyro bolt (200) in real time to diagnose problems when separation failure occurs.

Looking at an organic operating process between components, in an initial state the explosive bolt (100) is restrained together with the bolt head-type nut (240) by the pyro bolt (200) to fasten two structural members (270).

When power is applied to the first igniter (110), an internal explosive of the explosive bolt (100) explodes and the cutting portion (120) is separated.

At this time, the separation function is performed even if the pyro bolt (200) does not operate.

When power is applied to the second igniter (210), the split wedge (250) expands to release restraint of the bolt head-type nut (240), thereby performing separation of the structural member (270).

At this time, the separation function is performed even if the explosive bolt (100) does not operate.

Meanwhile, even when the explosive bolt (100) and the pyro bolt (200) operate simultaneously, the separation function may be normally performed without mutual interference.

Therefore, according to the present embodiment, the apparatus has a dual separation function in which separation is possible even when only one of the explosive bolt (100) and the pyro bolt (200) operates, thereby improving reliability.

In addition, combinations with explosive bolts (100) of various sizes are possible by changing the size of the bolt head-type nut (240).

Conventional explosive bolts (100) may be used as they are, and an operating concept of the pyro bolt (200) may also be maintained.

Safety may be maximized by including a sensor unit capable of monitoring states of respective devices when an operation failure occurs.

A highly reliable separation device may be secured in a short period of time without a new development process while utilizing the existing explosive bolt (100).

Accordingly, the present embodiment relates to the pyro separation apparatus (1000) having the dual separation function and compatibility with various fasteners, in which separation may be performed even when only one of the explosive bolt (100) and the pyro bolt (200) operates.

Through this configuration, reliability problems of existing single separation devices are solved and a safer and more reliable separation mechanism may be provided in missiles, satellites, and aerospace systems.

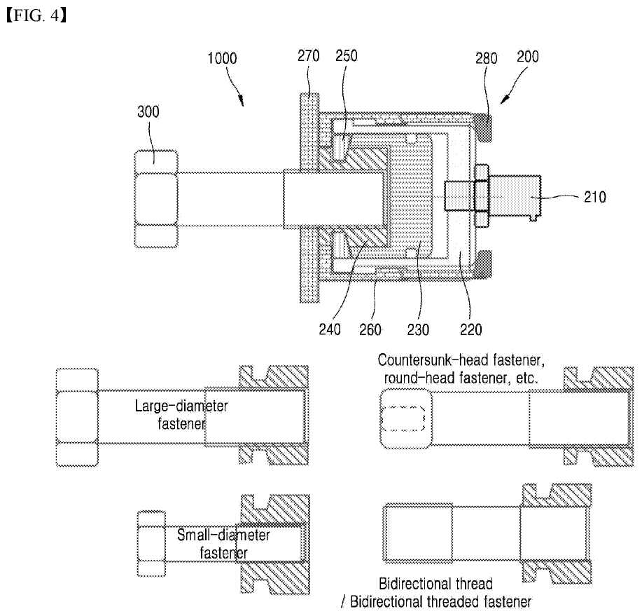

FIG. 4 is a view illustrating examples of application of various sizes of the pyro explosive bolt and fasteners in the dual separation apparatus using the pyro explosive bolt according to another exemplary embodiment of the present disclosure.

The present embodiment relates to a modified example in which various fasteners (300) can be applied by using the bolt head-type nut (240) as an intermediate component, separately from the dual separation structure shown in FIG. 3.

Referring to FIG. 4, a pyro separation apparatus (1000) having a dual separation function and compatibility with various fasteners according to the present disclosure may include a pyro bolt (200) and a fastener (300).

The pyro bolt (200) includes a second igniter (210), a cylinder (220), a piston (230), a bolt head-type nut (240), a split wedge (250), a case (260), a structural member (270), and an initial fixing member (280).

The cylinder (220) has a shape in which one side is open.

The second igniter (210) is connected to the other side of the cylinder (220) having one side open.

The piston (230) is inserted into the cylinder (220) and has a shape in which one side is open.

The bolt head-type nut (240) is inserted into the piston (230) and has a shape in which one side is open.

The split wedge (250) restrains the bolt head-type nut (240).

More specifically, the split wedge (250) restrains a vicinity of an outer surface of one side of the bolt head-type nut (240), and is restrained by an inner surface of one side of the cylinder (220) and one end of the piston (230).

The case (260) accommodates and protects the split wedge (250) and the cylinder (220).

More specifically, the case (260) surrounds the outer surfaces of the split wedge (250) and the cylinder (220).

The initial fixing member (280) is disposed outside the case (260) in a circumferential shape to fix the case (260).

When power is applied to the second igniter (210), the pyro bolt (200) causes the split wedge (250), which restrains the bolt head-type nut (240), to expand in a radial direction to release restraint of the bolt head-type nut (240) being restrained.

In addition, the pyro bolt (200) may operate as a single separation device by being coupled with the fastener (300).

In other words, the present embodiment is the pyro separation apparatus (1000) having the dual separation function and compatibility with various fasteners used in aerospace and defense industries.

In particular, the present embodiment is designed so that various fasteners can be applied instead of the explosive bolt (100), thereby providing a flexible separation function according to various environments and requirements together with reliability of the pyro bolt (200).

Through this configuration, stability and reliability of the separation apparatus can be improved, and applicability in various fastening environments can be secured.

The fastener (300) may include various types of fasteners such as a bolt, a large-diameter fastener, a small-diameter fastener, a bidirectional threaded fastener, a countersunk-head fastener, or a round-head fastener.

Such fasteners (300) may be adjustable to various shapes and sizes, for example, and each fastener (300) including threads may be screw-coupled with the bolt head-type nut (240) including thread grooves.

When the pyro bolt (200) operates, the separation function is performed through release of restraint of the bolt head-type nut (240).

Each fastener (300) is inserted into the bolt head-type nut (240) and is restrained by the split wedge (250) of the pyro bolt (200).

The bolt head-type nut (240) has a cylindrical structure with one side open, and a space for accommodating a head portion of various fasteners (300) is provided therein.

Such a bolt head-type nut (240) is adjustable in diameter and length and may be compatible with fasteners (300) of various sizes.

When the split wedge (250) of the pyro bolt (200) expands, restraint of the bolt head-type nut (240) is released so that the bolt head-type nut (240) is separated together with the fastener (300).

The bolt head-type nut (240) is restrained by the other side of the fastener (300) and the split wedge (250) of the pyro bolt (200), and operates together with the pyro bolt (200) during separation.

The second igniter (210) of the pyro bolt (200) is a power supply device for operating the pyro bolt (200).

The split wedge (250) is an element that restrains the bolt head-type nut (240), and expands in a radial direction when power is applied to release the restraint.

The cylinder (220) and the piston (230) are mechanical components inside the pyro bolt (200), and support expansion of the split wedge (250).

The cylinder (220) and the piston (230) have a cylindrical structure with one side open, and the split wedge (250) is inserted into the piston (230).

When power is applied to the second igniter (210), the split wedge (250) expands to release restraint of the bolt head-type nut (240) and performs the separation function together with various fasteners (300).

The pyro bolt (200) is a core device that restrains the bolt head-type nut (240), and may operate independently together with various fasteners (300).

Looking at an operating relationship, various fasteners (300) are restrained together with the bolt head-type nut (240) by the pyro bolt (200) to fasten the structural member (270).

When power is applied to the second igniter (210) and the split wedge (250) expands, restraint of the bolt head-type nut (240) is released, and separation of the structural member (270) is performed together with the fastener (300).

By changing a size of the bolt head-type nut (240), fasteners (300) of various sizes and shapes can be easily applied.

Accordingly, according to the present embodiment, various types of fasteners (300) can be applied instead of the explosive bolt (100) so as to respond to various separation environments.

In addition, since the separation function can be performed only by operation of the pyro bolt (200), reliability can be improved, and compatibility with various fasteners (300) is possible by changing the size of the bolt head-type nut (240).

In addition, through application of various fasteners (300), a highly reliable separation function can be secured without development of a separate explosive bolt (100).

Accordingly, the present embodiment provides a new configuration in which various fasteners (300) can be applied instead of the explosive bolt (100) in the pyro separation apparatus (1000) having the dual separation function and compatibility with various fasteners.

Through this configuration, a highly reliable separation function is provided in various environments, and a cost-efficient highly reliable separation apparatus can be secured within a short period of time

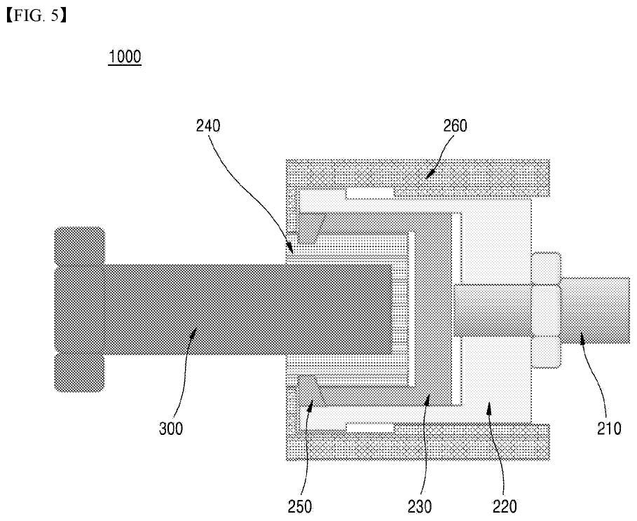

FIG. 5 is a view illustrating a configuration of a pyro separation apparatus capable of using various fasteners according to another exemplary embodiment of the present disclosure.

Referring to FIG. 5, a pyro separation apparatus (1000) having a dual separation function and compatibility with various fasteners according to the present disclosure includes a second igniter (210), a cylinder (220), a piston (230), a bolt head-type nut (240), a split wedge (250), a case (260), and a fastener (300).

The cylinder (220) has a shape in which one side is open.

The second igniter (210) is connected to the other side of the cylinder (220) having one side open.

The piston (230) is inserted into the open one side of the cylinder (220).

The bolt head-type nut (240) is inserted into the open one side of the piston (230).

The split wedge (250) restrains a vicinity of an outer surface of one side of the bolt head-type nut (240), and is restrained by an inner surface of one side of the cylinder (220) and one end of the piston (230).

The case (260) surrounds outer surfaces of the split wedge (250) and the cylinder (220).

The fastener (300) is inserted into the open one side of the bolt head-type nut (240).

A diameter and a length of the bolt head-type nut (240) are adjustable.

Here, the cylinder (220) moves in a direction opposite to the open one side, that is, in a direction of the other side, by pressure generated by the second igniter (210) to which power is applied.

By movement of the cylinder (220), the split wedge (250) expands in a radial direction to release restraint of the bolt head-type nut (240) being restrained.

By a pushing force of the piston (230) caused by the pressure generated by the second igniter (210), the bolt head-type nut (240) is separated from the piston (230).

Meanwhile, the pyro separation apparatus (1000) having the dual separation function and compatibility with various fasteners according to the present disclosure may further include a sensor unit and a control unit.

The sensor unit may individually monitor an operating state of the pyro separation apparatus (1000) having the dual separation function and compatibility with various fasteners when separation failure of the pyro separation apparatus (1000) having the dual separation function and compatibility with various fasteners occurs.

In addition, the control unit may control an operation sequence of the pyro separation apparatus (1000) having the dual separation function and compatibility with various fasteners.

That is, the control unit may control a pyro separation method capable of using various fasteners, which will be described later.

In other words, the apparatus according to the present embodiment relates to the pyro separation apparatus (1000) having the dual separation function and compatibility with various fasteners used in the aerospace industry, the defense industry, and the like.

The present embodiment relates to a configuration in which various fasteners (300) can be applied to the pyro separation apparatus by using the bolt head-type nut (240) as an intermediate component.

Through this configuration, various fastening conditions can be accommodated, and a burden of redesigning the apparatus according to changes in fastening conditions can be reduced.

In other words, in the pyro separation apparatus capable of using various fasteners, the second igniter (210) performs a role of generating pressure therein and moving the cylinder (220) when power is applied.

The second igniter (210) may, for example, be formed in a cylindrical shape, and may generate high-pressure gas therein.

The second igniter (210) is connected to the cylinder (220), and performs a role of pushing out the cylinder (220) when internal pressure increases.

That is, when power is applied to the second igniter (210), the second igniter (210) generates internal pressure and moves the cylinder (220), thereby starting operation of the separation apparatus.

The cylinder (220) has a structure that moves by internal pressure to release fixation of the split wedge (250).

The cylinder (220) may, for example, be formed in a cylindrical structure having an empty interior, and may be couplable with the piston (230).

The cylinder (220) moves by pressure of the second igniter (210).

The cylinder (220) has a structure including the piston (230) and the split wedge (250).

The cylinder (220) moves by internal pressure, and performs a role of releasing an initial fixed state and separating the bolt head-type nut (240).

The piston (230) receives pressure according to movement of the cylinder (220) and separates the restrained bolt head-type nut (240).

The piston (230) may, for example, be formed in a cylindrical structure insertable into the cylinder (220), and may be formed in a structure in which both ends are flat.

The piston (230) is positioned inside the cylinder (220), and may perform a role of restraining the split wedge (250).

The piston (230) moves according to a pressure change of the cylinder (220), and pushes out the bolt head-type nut (240) to induce separation.

The case (260) is a structure surrounding an outside of the apparatus, and performs a role of fixing the cylinder (220) and the split wedge (250).

The case (260) may, for example, be formed in a structure surrounding the cylinder (220) and the split wedge (250) from the outside.

The case (260) performs a role of protecting the entire apparatus, and performs a role of fixing the split wedge (250) so that the split wedge (250) can operate at a correct position.

The case (260) maintains structural integrity of internal elements of the apparatus and protects the apparatus from external impact.

The split wedge (250) is fixed by the cylinder (220), and when the cylinder (220) moves, the split wedge (250) expands in a radial direction and releases restraint of the bolt head-type nut (240).

The split wedge (250) may, for example, have a radially divisible structure, and may be formed so as to expand in a radial direction.

The split wedge (250) may be restrained by the cylinder (220) and the piston (230), and when the cylinder (220) moves, a fixing force is released so that the split wedge (250) may expand in a radial direction.

The split wedge (250) restrains the bolt head-type nut (240), and when the cylinder (220) moves, the split wedge (250) expands in a radial direction to release the restraint.

The bolt head-type nut (240) is a component designed to accommodate various fasteners (300) instead of a conventional pyro bolt, and maintains a fastened structure and is separated when necessary.

The bolt head-type nut (240) may, for example, be formed in a cylindrical structure in which threads are machined so as to be coupled with various fasteners (300).

The bolt head-type nut (240) is restrained by the split wedge (250), and may be separated together with expansion of the split wedge (250).

The bolt head-type nut (240) maintains a fastened state and may be formed to be separated when necessary.

The fastener (300) may use not only a general bolt but also a large-diameter or small-diameter fastener, a bidirectional threaded fastener, and a countersunk-head or round-head fastener.

The fastener (300) may, for example, include various forms such as a general bolt, a large-diameter or small-diameter fastener, a bidirectional threaded fastener, and a countersunk-head or round-head fastener.

The fastener (300) is coupled with the bolt head-type nut (240) to maintain a fastened state, and may be disassembled according to operation of the separation apparatus.

The fastener (300) supports various forms of fastening methods, thereby enabling various forms of fastening in one separation apparatus.

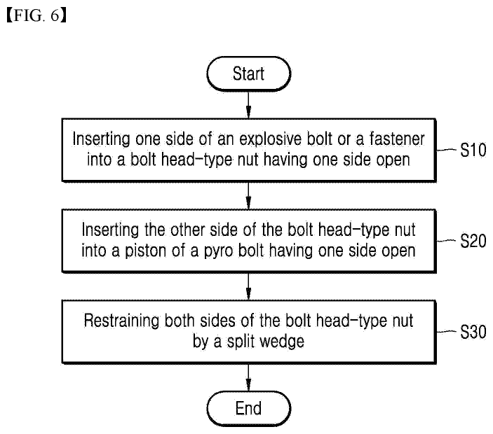

FIG. 6 is a flowchart illustrating an overall flow of a configuration or preparation stage of the dual separation apparatus in a dual separation method using the pyro explosive bolt according to an exemplary embodiment of the present disclosure.

Referring to FIG. 6, the dual separation method using the pyro explosive bolt according to the sixth exemplary embodiment of the present disclosure includes three steps.

In a first step (S10), one side of the explosive bolt (100) or the fastener (300) is inserted into a bolt head-type nut (240) having one side open.

In a second step (S20), the other side of the bolt head-type nut (240) is inserted into a piston (230) of a pyro bolt (200) having one side open.

In a third step (S30), both sides of the bolt head-type nut (240) are restrained by a split wedge (250).

In addition, in the dual separation method using the pyro explosive bolt according to the present disclosure, when power is applied to a first igniter (110) connected to the explosive bolt (100), a cutting portion (120) of the explosive bolt (100) may be separated by explosion of an internal explosive.

In addition, in the dual separation method using the pyro explosive bolt according to the present disclosure, when power is applied to a second igniter (210) connected to the pyro bolt (200), a split wedge (250) restraining the bolt head-type nut (240) may expand in a radial direction to release restraint of the bolt head-type nut (240) being restrained.

In addition, in the dual separation method using the pyro explosive bolt according to the present disclosure, when power is applied to the first igniter (110) connected to the explosive bolt (100), the cutting portion (120) of the explosive bolt may be separated by explosion of the internal explosive, or when power is applied to the second igniter (210) connected to the pyro bolt (200), the split wedge (250) restraining the bolt head-type nut (240) may expand in a radial direction to release restraint of the bolt head-type nut (240) being restrained.

Meanwhile, in the dual separation method using the pyro explosive bolt according to the present disclosure, a state in which the cutting portion (120) of the explosive bolt (100) is separated by explosion of the internal explosive when power is applied to the first igniter (110) connected to the explosive bolt (100), and a state in which the split wedge (250) restraining the bolt head-type nut (240) expands in a radial direction to release restraint of the bolt head-type nut (240) being restrained when power is applied to the second igniter (210) connected to the pyro bolt (200) may be performed simultaneously.

Here, the fastener (300) may be one selected from a bolt, a large-diameter or small-diameter fastener, a bidirectional threaded fastener, and a countersunk-head or round-head fastener.

In addition, the pyro bolt (200) may operate as a single separation apparatus by being coupled with the fastener (300).

In other words, the present embodiment relates to a dual separation method of the pyro separation apparatus (1000) having a dual separation function and compatibility with various fasteners used in the aerospace industry, the defense industry, and the like.

Here, the explosive bolt (100) includes the cutting portion (120) filled with an internal explosive and the first igniter (110).

The explosive bolt (100) has a cylindrical structure in which the cutting portion (120) is positioned near a center so as to be separated into two parts during explosion.

That is, when power is applied to the first igniter (110), the internal explosive explodes so that the cutting portion (120) is separated.

The explosive bolt (100) is coupled with the bolt head-type nut (240) and operates in conjunction with the pyro bolt (200).

The bolt head-type nut (240) has a cylindrical structure with one side open and may accommodate explosive bolts (100) or fasteners (300) of various sizes.

The bolt head-type nut (240) may adjust its size and diameter so as to be compatible with various fasteners (300).

When the split wedge (250) of the pyro bolt (200) expands, restraint of the bolt head-type nut (240) is released so that the bolt head-type nut (240) is separated together with the explosive bolt (100) or the fastener (300).

The bolt head-type nut (240) is restrained by the split wedge (250) of the pyro bolt (200), and operates together during separation.

The second igniter (210) of the pyro bolt (200) is a power supply device for operating the pyro bolt (200), and the split wedge (250) is an element that restrains the bolt head-type nut (240), and expands in a radial direction when power is applied so as to release the restraint.

The cylinder (220) and the piston (230) are mechanical components that support expansion of the split wedge (250).

The cylinder (220) and the piston (230) have a cylindrical structure with one side open, and the split wedge (250) is inserted into the piston (230).

When power is applied to the second igniter (210), the split wedge (250) expands to release restraint of the bolt head-type nut (240) and separates the structural member (270).

The pyro bolt (200) may operate independently together with various fasteners (300).

Looking at the dual separation method using the pyro explosive bolt, the explosive bolt (100) or the fastener (300) is inserted into the bolt head-type nut (240).

The bolt head-type nut (240) is inserted into the piston (230) of the pyro bolt (200) and is restrained by the split wedge (250).

The structural member (270) is stably fixed through the explosive bolt (100) or the fastener (300) and the bolt head-type nut (240).

Looking at the separation process using the explosive bolt (100), when power is applied to the first igniter (110), the internal explosive explodes and the cutting portion (120) is separated.

When separation is completed, an operating state may be monitored by the sensor unit.

Looking at the separation process using the pyro bolt, when power is applied to the second igniter (210), expansion of the split wedge (250) begins.

The split wedge (250) expands in a radial direction so that restraint of the bolt head-type nut (240) is released, and the explosive bolt (100) or the fastener (300) and the bolt head-type nut (240) are separated from the structural member (270).

A separation state may be monitored in real time through the sensor unit.

Looking at a simultaneous operation separation process, when power is simultaneously applied to the first igniter (110) and the second igniter (210), cutting of the explosive bolt (100) and expansion of the split wedge (250) of the pyro bolt (200) proceed simultaneously.

At this time, the separation function may be performed without mutual interference so that reliability may be improved.

As described above, according to the present embodiment, not only the explosive bolt (100) but also various types of fasteners (300) may be applied so that a flexible separation function may be provided, and the separation function may be performed even by independent operation of the pyro bolt (200) or the explosive bolt (100).

Accordingly, the present embodiment provides a highly reliable separation function, and a cost-efficient highly reliable separation apparatus may be secured within a short period of time.

Meanwhile, operation of the pyro bolt (200) is performed through the following process.

That is, pressure is generated in the second igniter (210) by power applied to the second igniter (210).

The cylinder (220) moves by pressure generated by the second igniter (210).

More specifically, the cylinder (220) moves in a direction in which the second igniter (210) is connected.

When the cylinder (220) moves, the split wedge (250) expands in a radial direction so that restraint of the bolt head-type nut (240) being restrained is released.

By a pushing force of the piston (230) caused by the pressure generated by the second igniter (210), the bolt head-type nut (240) is separated from the piston (230).

Here, the diameter and the length of the bolt head-type nut (240) are adjustable.

Meanwhile, in order to perform the separation method described above, the pyro bolt (200) should be connected in the following structure.

That is, the second igniter (210) is connected to the other side of the cylinder (220) having one side open.

The piston (230) having one side open is inserted into the cylinder (220) having one side open.

In addition, the bolt head-type nut (240) having one side open is inserted into the piston (230) having one side open.

Meanwhile, the split wedge (250) restraining a vicinity of an outer surface of one side of the bolt head-type nut (240) is restrained by an inner surface of one side of the cylinder (220) and one end of the piston (230).

The fastener (300) is inserted into one side of the open bolt head-type nut (240).

The fastener (300) may be one selected from the group consisting of a bolt, a large-diameter or small-diameter fastener, a bidirectional threaded fastener, and a countersunk-head or round-head fastener.

Outer surfaces of the split wedge (250) and the cylinder (220) are surrounded by the case (260).

In other words, when power is applied to the second igniter (210), high pressure is generated inside the cylinder (220).

This pressure acts as a force pushing the cylinder (220).

The cylinder (220) moves by the generated pressure.

At this time, according to movement of the cylinder (220), a fixing force restraining the split wedge (250) may be released.

As the cylinder (220) moves, the split wedge (250) expands in a radial direction.

During this expansion process, fixation of the bolt head-type nut (240), which was previously restrained, is released.

Due to expansion of the split wedge (250), restraint of the bolt head-type nut (240) is released, and the bolt head-type nut (240) and the fastener (300) are separated from the apparatus by the pushing force of the piston (230).

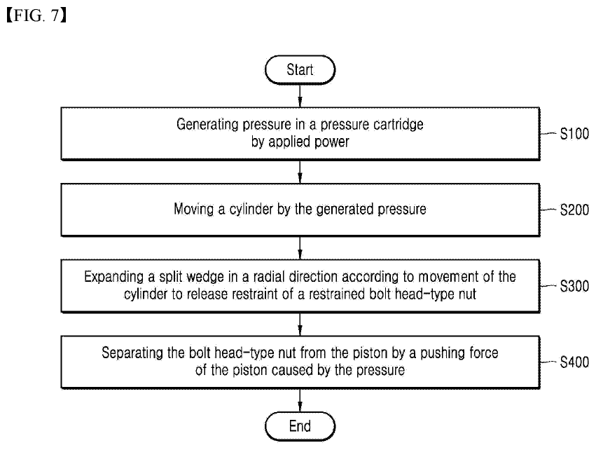

FIG. 7 is a flowchart illustrating an overall flow of an actual operation stage in a pyro separation method capable of using various fasteners according to another exemplary embodiment of the present disclosure.

The pyro separation apparatus (1000) having the dual separation function and compatibility with various fasteners described above may be separated by the pyro separation method having the dual separation function and compatibility with various fasteners according to the present embodiment.

Referring to FIG. 7, the pyro separation method having the dual separation function and compatibility with various fasteners according to another exemplary embodiment of the present disclosure includes four steps.

In a first step (S100), pressure is generated in the second igniter (210) by applied power.

In a second step (S200), the cylinder (220) moves by pressure generated by the second igniter (210).

More specifically, the cylinder (220) moves in a direction in which the second igniter (210) is connected.

In a third step (S300), when the cylinder (220) moves, the split wedge (250) expands in a radial direction to release restraint of the bolt head-type nut (240) being restrained.

In a fourth step (S400), the bolt head-type nut (240) is separated from the piston (230) by a pushing force of the piston (230) caused by pressure generated by the second igniter (210).

Here, a diameter and a length of the bolt head-type nut (240) are adjustable.

Meanwhile, in order for the separation method described above to be performed, the pyro separation apparatus (1000) having the dual separation function and compatibility with various fasteners should be connected in the following structure.

That is, the second igniter (210) is connected to the other side of the cylinder (220) having one side open.

The piston (230) having one side open is inserted into the cylinder (220) having one side open.

In addition, the bolt head-type nut (240) having one side open is inserted into the piston (230) having one side open.

Meanwhile, the split wedge (250) restraining a vicinity of an outer surface of one side of the bolt head-type nut (240) is restrained by an inner surface of one side of the cylinder (220) and one end of the piston (230).

A fastener (300) is inserted into one side of the open bolt head-type nut (240).

The fastener (300) may be one selected from the group consisting of a bolt, a large-diameter or small-diameter fastener, a bidirectional threaded fastener, and a countersunk-head or round-head fastener.

Outer surfaces of the split wedge (250) and the cylinder (220) are surrounded by the case (260).

In other words, in the pyro separation method capable of using various fasteners according to an embodiment of the present disclosure, in the first step (S100), when power is applied to the second igniter (210), high pressure is generated inside the cylinder (220).

This pressure acts as a force pushing the cylinder (220).

In the second step (S200), the cylinder (220) moves by the generated pressure.

At this time, according to movement of the cylinder (220), a fixing force restraining the split wedge (250) may be released.

In the third step (S300), as the cylinder (220) moves, the split wedge (250) expands in a radial direction.

During this expansion process, fixation of the bolt head-type nut (240), which was previously restrained, is released.

In the fourth step (S400), due to expansion of the split wedge (250), restraint of the bolt head-type nut (240) is released, and the bolt head-type nut (240) and the fastener (300) are separated from the apparatus by the pushing force of the piston (230).

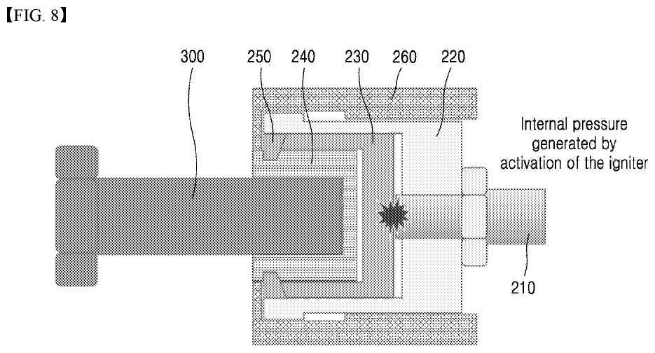

FIG. 8 is a view illustrating a first step of the pyro separation method capable of using various fasteners according to another exemplary embodiment of the present disclosure.

Referring to FIG. 8, in the first step (S100) according to the embodiment of the present disclosure, pressure is generated in the second igniter (210) by applied power.

In this first step (S100), the second igniter (210) is activated by power applied from the outside.

High-pressure gas or hydraulic pressure is generated through a chemical or mechanical action inside the second igniter (210).

The generated pressure is transmitted to an inside of the cylinder (220), and thereafter becomes a driving force for moving the cylinder (220) in a subsequent step.

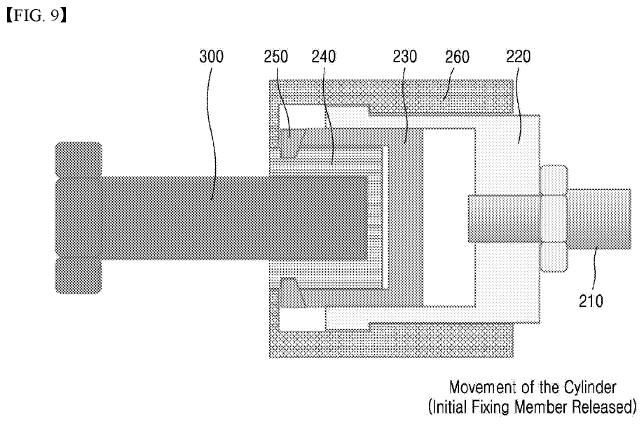

FIG. 9 is a view illustrating a second step of the pyro separation method capable of using various fasteners according to another exemplary embodiment of the present disclosure.

Referring to FIG. 9, in the second step (S200) according to the embodiment of the present disclosure, the cylinder (220) moves by the pressure generated by the second igniter (210).

The pressure formed in the first step (S100) performs a role of moving the cylinder (220) in an axial direction.

The movement of the cylinder (220) induces release of the split wedge (250) that had been restrained inside.

In a conventional pyro bolt separation device, the cylinder (220) presses the split wedge (250), which is split, to maintain a fastened state. However, in the present embodiment, the split wedge (250), which is split, moves in a radial direction by movement of the cylinder.

In this process, restraint of the bolt head-type nut (240), which is a component maintaining an interface with the fastener (e.g., a general bolt, a nut, etc.), is released.

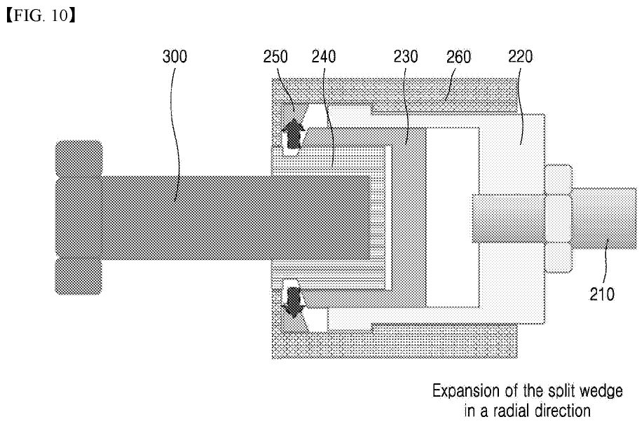

FIG. 10 is a view illustrating a third step of the pyro separation method capable of using various fasteners according to another exemplary embodiment of the present disclosure.

Referring to FIG. 10, in the third step (S300) according to the embodiment of the present disclosure, when the cylinder (220) moves, the split wedge (250) expands in a radial direction to release restraint of the bolt head-type nut (240) that is under restraint.

In the third step (S300), when the cylinder (220) moves, the split wedge (250) expands in a radial direction, and a state in which the fastener (300) had been restrained is released.

That is, the bolt head-type nut (240) no longer maintains fastening force with a structure.

In a conventional pyro bolt method, a special bolt has to be custom-manufactured in a unique shape, but in the present embodiment, a separation mechanism can be formed so that various fasteners can be used by the bolt head-type nut (240).

As the split wedge (250) expands, the bolt head-type nut (240) is no longer structurally fixed and becomes in a state in which the bolt head-type nut (240) can move freely by an external force (e.g., pressure of the piston (230)).

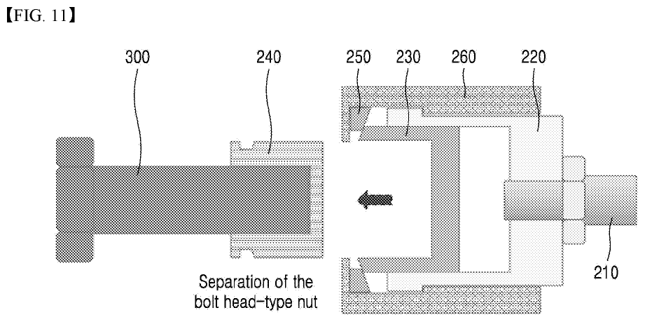

FIG. 11 is a view illustrating a fourth step of the pyro separation method capable of using various fasteners according to another exemplary embodiment of the present disclosure.

Referring to FIG. 11, in the fourth step (S400) according to the embodiment of the present disclosure, the bolt head-type nut (240) is separated from the piston (230) by a pushing force of the piston (230) generated by pressure produced by the second igniter (210).

In the fourth step (S400), simultaneously with expansion of the split wedge (250), the piston (230) receives a strong force in an axial direction by the generated pressure.

The piston (230) is pushed by internal pressure and separates the bolt head-type nut (240), which had previously been restrained, from a structural member.

In this process, the fastener (300), which had been fastened together with the bolt head-type nut (240), is simultaneously separated.

Since the bolt head-type nut (240) used in the present embodiment is formed to be compatible with various fasteners (300), bolts of various standards can be easily applied.

After the fastening state is released, when the piston (230) returns, a new fastener (300) may be applied again for reuse.

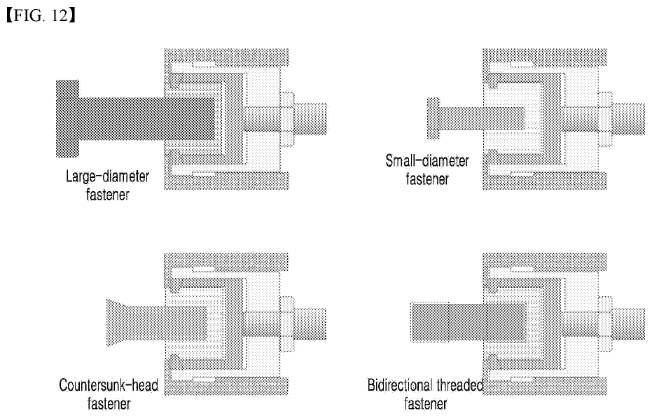

FIG. 12 is a view illustrating a configuration of a pyro separation apparatus capable of using various fasteners according to still another exemplary embodiment of the present disclosure.

Referring to FIG. 12, in the pyro separation apparatus (1000) having a dual separation function and compatibility with various fasteners according to the present disclosure, the fastener (300) may be one of a bolt, a fastener having a large diameter or a small diameter, a bidirectional threaded fastener, and a countersunk-head fastener or a round-head fastener.

In summary, in the pyro separation apparatus (1000) having the dual separation function and compatibility with various fasteners according to the present disclosure, when pressure is applied to an inside by the second igniter (210) to move the cylinder (220), initial fixation is released, and the split wedge (250), which is split, moves in a radial direction to release restraint of the bolt head-type nut (240), and the bolt head-type nut (240) is separated by a pushing force of the piston (230), thereby releasing fastening.

The bolt head-type nut (240) is an element designed to apply various fasteners (300) in a manner similar to a pyro bolt, and when fixation by the split wedge (250), which is split, is released, the bolt head-type nut (240) is separated together with the fastener (300) used.

Since a conventional pyro bolt separation device is custom-manufactured according to specifications required by a projectile, it is difficult to apply the device to other projectiles, and there is inconvenience in that a performance verification test has to be conducted whenever the device is manufactured.

However, the pyro separation apparatus (1000) having the dual separation function and compatibility with various fasteners according to the present disclosure uses the bolt head-type nut (240), and an external shape of the bolt head-type nut (240) is designed in consideration of an interface with the split wedge (250) and the like, and a threaded portion inside the bolt head-type nut (240) is machined according to a standard specification of general fasteners.

According to a type of the fastener (300), only the bolt head-type nut (240) portion may be manufactured according to various thread standards and subjected to a performance verification test, and when requirements of the projectile are satisfied, the bolt head-type nut (240) may be applied.

Referring to FIG. 12, in the present embodiment, the pyro separation apparatus (1000) having the dual separation function and compatibility with various fasteners can reduce a need for custom machining of a special bolt required for separation even when fastening conditions change.

For example, if a bolt head-type nut (240) in which a threaded portion is not machined is prepared in advance and post-machining is performed according to conditions of the fastener (300), manufacturing cost can be reduced.

In addition, even when a bolt is damaged during an assembly process, it is possible to more flexibly respond to urgent demand by using commercial fasteners, and economic utilization is possible in that development cost is reduced.

According to the present disclosure, by applying a dual separation mechanism so that the separation function can be performed even when only one of a pyro bolt and an explosive bolt operates, even if the reliability of each bolt is somewhat low, the dualized design maximizes the separation reliability of the entire system and minimizes the possibility of separation failure, thereby improving stability and safety of a flight vehicle and other important systems.

In addition, according to the present disclosure, by introducing a bolt-head type nut, an already developed explosive bolt can be used as it is, and the explosive bolt can be combined with the pyro bolt without separate redesign, thereby reducing design complexity and development cost, which leads to saving of time and resources and shortening of a development period of a project.

In addition, according to the present disclosure, by adjusting a size of the bolt-head type nut, the apparatus can be used in combination with explosive bolts of various sizes and types, and even when general fasteners are used instead of explosive bolts, the separation function of the pyro bolt can be maintained, thereby providing wide applicability and facilitating customized design according to requirements of various launch vehicles and structures.

In addition, according to the present disclosure, whereas it was difficult to identify a cause of malfunction when separation failure occurred in the related art, the dual separation device of the present disclosure can distinguish and confirm an operating state based on whether one of the bolts operates, thereby reducing time and cost required for maintenance and troubleshooting through effective cause analysis.

In addition, according to the present disclosure, extensive testing processes required for development of a new separation device can be shortened, testing and verification costs can be reduced based on existing reliable explosive bolts and pyro bolts, and efficiency in design and manufacturing processes can be improved to provide high performance relative to cost.

In addition, according to the present disclosure, a safe and highly reliable separation system can be provided in fields requiring high reliability, such as launch vehicle separation, satellite separation, and ballistic systems, and by preventing critical separation failure, the present disclosure can contribute to improvement of a mission success rate.

In addition, fasteners of various sizes and shapes can be applied to a single separation device, so that even when fastening conditions are changed there is no need to develop a new separation device, and fasteners having different diameters or special thread structures can also be made compatible through simple post-machining, thereby securing versatility applicable to various launch vehicles and structures through a standardized design.

In addition, according to the present disclosure, while maintaining a standardized external structure, when fastening conditions are changed, only the bolt head-type nut can be post-machined and manufactured, thereby eliminating the need to develop an entirely new device, reducing development and manufacturing costs, significantly shortening manufacturing and verification time, and enabling rapid response even in the event of urgent demand by allowing commercially available fasteners to be immediately applied.

In addition, according to the present disclosure, since the same separation mechanism is maintained through a modular design, a verification burden can be reduced, and a radial expansion split wedge structure of the pyro bolt provides a highly reliable separation operation, maintains stability of a structure, and provides stable and reliable separation performance even in various environments such as vibration and temperature changes.

In addition, according to the present disclosure, when an existing pyro bolt is damaged or separation failure occurs, commercial fasteners can be utilized and flexible response is possible even in emergency situations, thereby enabling rapid maintenance and reuse without delay of a launch vehicle, shortening a launch preparation period, and reducing operational costs.

In addition, according to the present disclosure, a size and structure of the bolt-head type nut can be adjusted according to fasteners of various sizes and structures, thereby enabling customized application according to fastening conditions required in various industries such as satellites, launch vehicles, and military supplies, and due to the modular design a single design can be applied to various application products, thereby providing excellent expandability.

In addition, according to the present disclosure, when the pyro bolt operates, a second igniter and a piston structure provide pressure required for a separation operation so that a safe separation process can be provided and risk of excessive damage can be reduced, thereby improving safety of the separation operation and providing a reliable separation function even in fields requiring high safety and precision such as aerospace and defense industries.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMERALS

100: explosive bolt
110: first igniter
120: cutting portion
200: pyro bolt
210: second igniter
220: cylinder
230: piston
240: bolt head-type nut
250: split wedge
260: case
270: structural member
280: initial fixing member
300: fastener
1000: pyro separation apparatus having a dual separation function and compatibility with various fasteners

What is claimed is:

1. A pyro separation apparatus having a dual separation function and compatibility with various fasteners for separating a fastening state of a structural member, the pyro separation apparatus comprising:
an explosive bolt configured such that a cutting portion is separated by explosion of an internal explosive;
a bolt head-type nut configured such that one side of the explosive bolt is inserted therein; and
a pyro bolt including a second igniter, a cylinder having one side open, a piston inserted into the cylinder, a split wedge configured to restrain the bolt head-type nut, and a case surrounding the split wedge and an outer side of the cylinder, wherein, when power is applied to the second igniter, the split wedge expands in a radial direction to release restraint of the bolt head-type nut,
wherein the explosive bolt performs separation of the structural member by separation of the cutting portion when power is applied to a first igniter,
wherein the pyro bolt performs separation of the structural member by releasing restraint of the bolt head-type nut by expansion of the split wedge, and
wherein separation of the structural member is performed by operation of the explosive bolt, the pyro bolt, or both.

2. The pyro separation apparatus of claim 1,
wherein the explosive bolt includes the first igniter and the cutting portion having one side connected to the first igniter,
wherein the cutting portion is positioned between one side and the other side of the explosive bolt, and
wherein the cutting portion is separated when power is applied to the first igniter.

3. The pyro separation apparatus of claim 1,
wherein the bolt head-type nut is formed in a shape having one side open, and
wherein a space is formed in the bolt head-type nut for accommodating a threaded part of the explosive bolt or one side of a fastener.

4. The pyro separation apparatus of claim 1,
wherein the split wedge restrains a vicinity of an outer surface of one side of the bolt head-type nut, and is restrained by an inner surface of one side of the cylinder and by one end of the piston.

5. The pyro separation apparatus of claim 1,
wherein the case is formed to accommodate and protect the split wedge and the cylinder, and
wherein an initial fixing member is disposed outside the case to fix the case.

6. The pyro separation apparatus of claim 1,
wherein the explosive bolt and the pyro bolt are arranged and configured to perform a normal separation function even when the explosive bolt and the pyro bolt operate simultaneously.

7. The pyro separation apparatus of claim 1,
wherein the bolt head-type nut is formed such that a diameter, a length, or both are changeable so as to be fastened with explosive bolts of a plurality of sizes.

8. The pyro separation apparatus of claim 1, further comprising:
a sensor unit configured to detect an operating state of the explosive bolt and the pyro bolt; and
a control unit configured to control an operation sequence of the first igniter and the second igniter.

9. A pyro separation apparatus capable of using various fasteners for separating a fastening state of a structural member, the pyro separation apparatus comprising:
a second igniter;
a cylinder having one side open;
a piston inserted into the open one side of the cylinder;
a bolt head-type nut installed in series with the piston and formed such that a fastener is inserted or coupled thereto;
a split wedge configured to restrain a vicinity of an outer surface of one side of the bolt head-type nut; and
a case surrounding the split wedge and an outer side surface of the cylinder;
wherein, when power is applied to the second igniter, pressure is generated,
wherein the cylinder moves by the pressure,
wherein, according to movement of the cylinder, the split wedge expands in a radial direction to release restraint of the bolt head-type nut,
wherein the bolt head-type nut is configured to be separated by a pushing force of the piston caused by the pressure, and
wherein the bolt head-type nut is formed to be selectively coupled with a fastener selected from the group consisting of a general bolt, a large-diameter or small-diameter fastener, a bidirectional threaded fastener, a countersunk-head fastener, and a round-head fastener.

10. The pyro separation apparatus of claim 9,
wherein the bolt head-type nut is formed in a cylindrical structure having one side open, and
wherein a space is provided in the bolt head-type nut for accommodating one side of the fastener.

11. The pyro separation apparatus of claim 9,
wherein the bolt head-type nut is formed such that a diameter, a length, or both are changeable so as to be compatible with fasteners of various sizes.

12. The pyro separation apparatus of claim 9,
wherein an internal threaded portion of the bolt head-type nut is formed to be post-processable according to a specification of an applicable fastener.

13. The pyro separation apparatus of claim 9,
wherein the split wedge has a radially divisible structure, and
wherein, when the cylinder moves, a fixing force is released so that the split wedge expands in a radial direction.

14. The pyro separation apparatus of claim 9,
wherein the case surrounds the cylinder and the split wedge from the outside, and
wherein the case maintains structural integrity of internal elements of the apparatus and protects the internal elements from external impact.

15. The pyro separation apparatus of claim 9, further comprising:
a sensor unit configured to detect an operating state of the pyro separation apparatus; and
a control unit configured to control an operation of the second igniter.

16. A pyro separation method having a dual separation function and compatibility with various fasteners for separating a fastening state of a structural member, the method comprising:
inserting one side of an explosive bolt or a fastener into a bolt head-type nut having one side open;
inserting the other side of the bolt head-type nut into a piston of a pyro bolt having one side open;
restraining the bolt head-type nut by a split wedge;
applying power to a first igniter to separate a cutting portion of the explosive bolt; and
applying power to a second igniter to generate pressure, moving a cylinder by the pressure, expanding the split wedge in a radial direction according to movement of the cylinder to release restraint of the bolt head-type nut, and separating the bolt head-type nut by a pushing force of the piston caused by the pressure;
wherein separation of the structural member is performed by operation of the explosive bolt, the pyro bolt, or both.

17. The pyro separation method of claim 16,
wherein a step of separating the cutting portion of the explosive bolt by the first igniter and a step of releasing the restraint of the bolt head-type nut by the second igniter are selectively performed or simultaneously performed.

18. The pyro separation method of claim 16,
wherein the fastener is selected from the group consisting of a general bolt, a large-diameter or small-diameter fastener, a bidirectional threaded fastener, a countersunk-head fastener, and a round-head fastener.

19. The pyro separation method of claim 16,
wherein at least one of a diameter, a length, or an internal thread specification of the bolt head-type nut is adjusted according to a specification of an applicable fastener or explosive bolt.

20. The pyro separation method of claim 16, further comprising:
detecting an operating state of the explosive bolt and the pyro bolt by a sensor unit; and
controlling an operation sequence of the first igniter and the second igniter by a control unit.
